(19) United States
(12) Patent Application Publication
(10) Pub. No.: US 2009/0097809 A1
(43) Pub. Date: Apr. 16, 2009

(54) Ferroelectric all-polymer hollow bragg fibers for terahertz guidance

(75) Inventors: Maksim Skorobogatiy, Kirkland (CA); Alexandre Dupuis, Dollard des Ormeaux (CA)

Correspondence Address: BCF LLP, 1100 RENE'-LE'VESQUE BLVD. WEST, 25TH FLOOR, MONTREAL, QC, H3B-5C9, CA

(73) Assignee: CORPORATION DE L'ECOLE POLYTECHNIQUE DE MONTREAL, Montreal (CA)

(21) Appl. No.: 12/213,915

(22) Filed: Jun. 26, 2008

Related U.S. Application Data
(60) Provisional application No. 60/929,403, filed on Jun. 26, 2007.

(51) Int. Cl. G02B 6/032

(52) U.S. Cl. 385/125; 264/1.28

(57) ABSTRACT

A method for fabricating a terahertz waveguide comprises forming a multilayer reflector formed of alternating layers of first and second polymer materials with distinct refractive indices, and defining with the multilayer reflector a hollow core through which terahertz radiation propagates. The corresponding terahertz waveguide comprises the multilayer reflector formed of the alternating layers of the first and second polymer materials with distinct refractive indices, and a hollow core defined by the multilayer reflector and through which terahertz radiation propagates.

### TECHNICAL FIELD

The present invention relates to ferroelectric all-polymer hollow Bragg fibers for terahertz (THz) guidance.

### BACKGROUND

Waveguides for the terahertz (THz) regime have recently received considerable attention due to the potential of this wavelength region for biochemical sensing, noninvasive imaging, and spectroscopy. Terahertz wavelengths cover the range of 30-3000 μm, bridging the gap between the microwave and optical regimes.

One of the earliest applications of terahertz radiation was spectroscopy and chemical identification of gases [1]. It was also recognized that, due to substantial subsurface penetration of the terahertz radiation into dry dielectrics, it could be used for tomographic imaging and quality control of electronic circuits ([2] and [3]). Combining spectroscopic and imaging approaches resulted in propositions for nondestructive detection applications such as sensing and spatial mapping of specific organic compounds for security applications [3]. Although terahertz radiation is strongly absorbed by water, biological tissue imaging has also been demonstrated ([4] and [5]). Finally, time resolved terahertz spectroscopy offers a non contact method of measuring the time dependent dielectric response of material [6].

Development of waveguides for terahertz is motivated by the need for remote delivery of broad band terahertz radiation from a generally bulky terahertz source. The main challenge in the design of terahertz waveguides is the high absorption losses of most materials in the terahertz region. These losses hinder the development of solid core total internal reflection (TIR) fibers, while the high losses of metals hinder the development of hollow metallic waveguides.

The earliest terahertz waveguides were metal electrodes on a semiconductor substrate [7] exhibiting a ˜100 dB/cm transmission loss at a frequency of ˜1 THz. Later, solid core TIR waveguides such as a single mode plastic ribbon waveguide [8], a single crystal sapphire fiber [9] and a stainless steel hollow core fiber [10] were demonstrated to present a ˜5 dB/cm loss at a frequency of ˜1 THz.

Recently, a variety of complex low loss waveguides have been demonstrated at the frequency of 1 THz. These waveguides include plastic solid core holey fibers with a transmission loss of 1-3 dB/cm ([11] and [12]), copper plates separated by a small air gap with a transmission loss of 0.5 dB/cm [13], subwavelength plastic fibers with a transmission loss of 0.5 dB/cm [14], hollow polymer waveguides with inner metallic or metallic-like layers having a transmission loss of 620 dB/m ([15], [16] and [17]) and metal wires with plasmon mediated guidance with a transmission loss of 1-10 dB/m ([18] and [19]).

### SUMMARY OF THE INVENTION

More specifically, in accordance with the present invention, there is provided a method for fabricating a terahertz waveguide, comprising: forming a multilayer reflector formed of alternating layers of first and second polymer materials with distinct refractive indices; and defining with the multilayer reflector a hollow core through which tetrahertz radiation propagates.

The present invention also relates to a terahertz waveguide, comprising: a multilayer reflector formed of alternating layers of first and second polymer materials with distinct refractive indices; and a hollow core defined by the multilayer reflector and through which tetrahertz radiation propagates.

The foregoing and other objects, advantages and features of the present invention will become more apparent upon reading of the following non restrictive description of an illustrative embodiment thereof, given by way of example only with reference to the accompanying drawings.

### BRIEF DESCRIPTION OF THE DRAWINGS

In the appended drawings:

FIG. 1 illustrates a non-restrictive illustrative embodiment of a hollow all-polymer Bragg fiber (or preform) according to the present invention, fabricated by consecutive deposition of ferroelectric polyvinylidene fluoride (PVDF) and low loss polycarbonate (PC) polymer layers on the inside of a PC tube by solvent evaporation;

FIG. 2 is a side elevational view of the non-restrictive illustrative embodiment of the hollow all-polymer Bragg fiber (or preform) according to the non-restrictive illustrative embodiment of the present invention, fabricated by the co-rolling of PVDF/PC films;

FIG. 3 is an illustration of the hollow all-polymer Bragg fiber according to the non-restrictive embodiment of the present invention, fabricated by drawing a smaller diameter fiber from the fiber of FIG. 2;

FIG. 4 is a graph of the real (Re) and imaginary (Im) parts of refractive indices of the reflector material versus the frequency in THz;

FIG. 5 is a graph illustrating the reflection efficiency (loss per single reflection (TM (Transverse Magnetic) polarization)) from the semi-infinite PC and PVDF layers, as well as from an optimized reflector as a function of the frequency in THz;

FIG. 6 is a graphical representation of a grazing angle of incidence θ;

FIG. 7 is a map of loss per single reflection from an infinite periodic reflector as a function of the layer thicknesses d_{PVDF} and d_{PC}, at a frequency of 0.1 terahertz and a grazing angle of incidence θ=89°;

FIG. 8 is a map of loss per single reflection from an infinite periodic reflector as a function of the layer thicknesses d_{PVDF} and d_{PC}, at a frequency of 0.6 terahertz and a grazing angle of incidence θ=89°;

FIG. 9 is a map of loss per single reflection from an infinite periodic reflector as a function of the layer thicknesses d_{PVDF} and d_{PC}, at a frequency of 2.0 terahertz and a grazing angle of incidence θ=89°;

FIG. 10 is a map of loss per single reflection from an infinite periodic reflector as a function of the layer thicknesses d_{PVDF} and d_{PC}, at a frequency of 1.2 terahertz and a grazing angle of incidence θ=89°;

FIG. 11 is a map of loss per single reflection from an infinite periodic reflector as a function of the layer thicknesses d_{PVDF} and d_{PC}, at a frequency of 3.0 terahertz and a grazing angle of incidence θ=89°;

FIG. 12 is a cross sectional view of a hollow Bragg fiber having a core with a 1 mm radius;

FIG. 13 is a map of the transmission loss of the hollow Bragg fiber of FIG. 12 as a function of the reflector layer thickness at a frequency of 1.1 terahertz;

FIG. 14 is a map of the transmission loss of the hollow Bragg fiber of FIG. 12 as a function of the reflector layer thickness at a frequency of 2.0 terahertz;

FIG. 15 is a map of the transmission loss of the hollow Bragg fiber of FIG. 12 as a function of the reflector layer thickness at a frequency of 3.0 terahertz; and

FIG. 16 is a graph of the transmission loss versus frequency (THz) of an optimal hollow Bragg fiber compared to the transmission loss versus frequency (THz) of a 1 mm core diameter PVDF tube guide.

### DETAILED DESCRIPTION

Generally stated, the non-restrictive, illustrative embodiment of the present invention is concerned with a terahertz waveguide, more specifically a hollow all-polymer Bragg fiber featuring a periodic multilayer reflector consisting of ferroelectric polyvinylidene fluoride (PVDF) and low loss polycarbonate (PC) polymers. According to the non-restrictive, illustrative embodiment of the present invention, a hollow all-polymer Bragg fiber is defined as a multilayer fiber in a cylindrical geometry.

Hidaka et al. [17] have demonstrated that when a layer of ferroelectric PVDF polymer is placed on the inside of a plastic tube, the resulting structure presents an efficient terahertz waveguide. Detailed analysis shows that PVDF polymer exhibits efficient metal-like reflectivity and considerably lower absorption losses compared to those of metals in the vicinity of 1 THz.

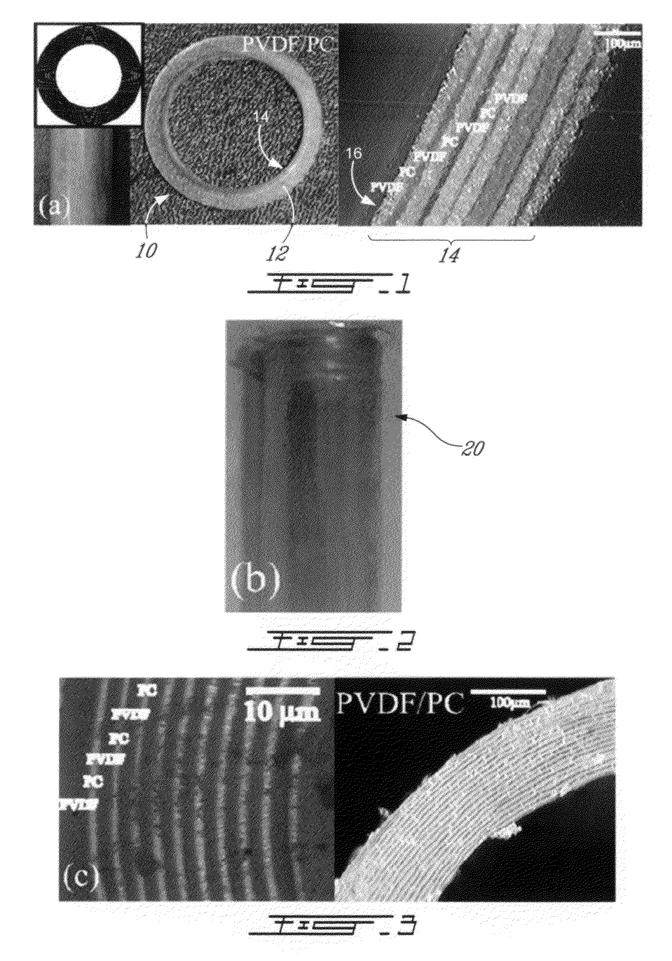

According to a first example of fabrication method, illustrated in FIG. 1, a terahertz hollow all-polymer Bragg fiber may be fabricated using consecutive depositions of polymer layers 14 on the inside of a rotating polymer tube 12 [20]. For example, solvent evaporation can be used for depositing the polymer layers 14 on the inside of the rotating polymer tube 12; of course, this does not exclude the use of any other suitable process to perform such deposition. In the example of FIG. 1, alternate layers of ferroelectric PVDF and low loss PC polymers are deposited. It should be noted that increasing the number of layers can reduce steadily the transmission loss until a saturation point, defined by the absorption loss of the materials of the layers, is reached. Generally, the transmission loss includes radiation loss and absorption loss. The radiation loss can be reduced considerably by having a large number of layers. Therefore, one should choose a number of layers large enough to eliminate the radiation loss. However, a too large number of layers may not be helpful because of the absorption loss induced by the material of the layers. The number of layers can be optimized by taking into consideration the radiation and absorption losses.

Also, the rotating polymer tube 12 can be made of PC polymer although use of other suitable materials, such as PVDF polymer, can be contemplated. This first fabrication method produces a large core diameter preform 10, for example a ˜1 cm diameter preform, which can then be used to form the terahertz waveguide. For example, a coaxial smaller diameter portion of the large core diameter preform 10 can be drawn from the preform 10 to form a hollow all-polymer Bragg fiber.

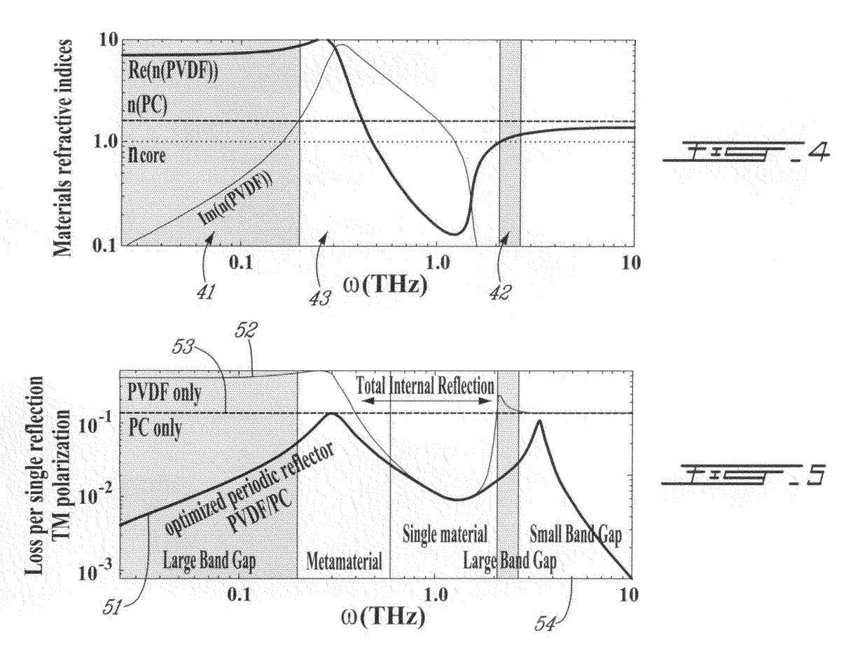

According to a second example of fabrication method, illustrated in FIG. 2, a hollow all-polymer Bragg fiber may be fabricated by co-rolling and solidifying a pair of superposed dissimilar polymer films, for example a pair of superposed ferroelectric PVDF polymer film and low loss PC polymer film. This second fabrication method also results in a larger core diameter preform 20, from which a smaller diameter hollow all-polymer Bragg fiber as illustrated in FIG. 3 may be later drawn [21].

The hollow all-polymer Bragg fiber as fabricated by either the above described the first or second examples of fabrication methods features a periodic reflector containing ferroelectric PVDF and low loss PC polymer materials. Also, the hollow all-polymer Bragg fiber may be designed to exhibit large terahertz band gaps near the transverse optical frequency of the ferroelectric PVDF material, as will be described in the following description.

It should be understood that, depending on the frequency of operation, the optimal hollow core Bragg fiber having the lowest loss will be of different types, for example one of the following: a photonic crystal fiber guiding in a band gap regime, a metamaterial fiber with a subwavelength reflector period, a single PC tube of a specific thickness or a single PVDF tube of any thickness.

An additional step in the above described first and second examples of fabrication methods may be needed before the hollow all-polymer Bragg fibers as shown in FIGS. 1-3 may be used as terahertz waveguides. More specifically, the PVDF polymer has to be “activated” via a poling process to become ferroelectric. As well known to those of ordinary skill in the art, the PVDF polymer is non-ferroelectric in an alpha phase but it is ferroelectric in a beta phase. To induce transition of the PVDF polymer from the alpha phase to the beta phase, the PVDF polymer has to be activated, for example, by a poling process. A poling process consists of applying an electric field with a given distribution and magnitude within the PVDF polymer during a poling time at a poling temperature to render the PVDF material ferroelectric. The poling process may be performed either during or after drawing of the hollow all-polymer Bragg fiber from the preform as described hereinabove. Depending on the technique and amount of poling used, guidance in such hollow all-polymer Bragg fibers may vary. Thus, a detailed understanding of the influence of poling conditions (poling electric field distribution and magnitude, poling time, poling temperature) on the PVDF dielectric constant (∈_{PVDF}) is required to obtain suitable transmission characteristics, in particular a suitable dielectric constant (∈_{PVDF}) of the PVDF polymer. The process of poling is believed to be otherwise well known to those of ordinary skill in the art and, accordingly, will not be further described in the present disclosure.

Also, in order to help activation of the PVDF polymer, nanoclays or ferroelectric powders can be used and added to the PVDF polymer.

It should be noted that other types of polymer materials, other than the above mentioned PVDF and PC polymers, can be used in the fabrication of hollow all-polymer Bragg fibers as shown in FIGS. 1-3, as long as such other polymer materials exhibit similar transmission characteristics in the tetrahertz region.

Transmission Through the Hollow Core all-Polymer Ferroelectric Bragg Fibers

Confinement of light radiation in the hollow all-polymer Bragg fiber is caused by a reflector formed by the periodic sequence of alternating ferroelectric PVDF and low loss PC polymer layers (see for example 14 in FIG. 1) with respective thicknesses d_{PVDF} and d_{PC}, and with a ferroelectric PVDF polymer layer 16 (FIG. 1) closest to the hollow core (coaxial central empty space), for example. Furthermore, the PC layer can also be closest to the hollow core instead of the PVDF layer. In this case, the transmission loss will be changed.

It is assumed that the diameter of the hollow core is significantly larger than the wavelength of the transmitted or propagated light radiation. Generally, a large diameter of a core fiber reduces coupling loss of that fiber. Light propagation in such fibers may be seen as a sequence of consecutive reflections at grazing angles of incidence upon an almost planar reflector. For example, referring to FIG. 6, the grazing angle of incidence is about 90° (θ=90°).

Also, in the terahertz region, the PVDF dielectric function ∈_{PVDF}(ω) exhibits a resonance given by the following equation:

$${ɛ}_{PVDF} ( ω ) = {ɛ}_{OPT} + \frac{( {ɛ}_{dc} - {ɛ}_{opt} ) {ω}_{TO}^{2}}{{ω}_{TO}^{2} - {ω}^{2} + iγω} , \qquad ( 1 )$$

where, according to Hidaka et al. [17], the parameters ∈ₒₚₜ=2.0, ∈_{dc}=50.0, ωᵣₒ=0.3 THz, and γ=0.1 THz. It should be noted that other expressions for the dielectric function can be also used, with different values for the above-mentioned parameters. Those values can be determined using experimental data.

It can be shown that any material, which has a resonance in its dielectric function similar to that of Equation (1), can be used to replace the ferroelectric PVDF polymer in the fabrication of the hollow Bragg fiber as illustrated in FIGS. 1-3 for use as THz waveguide.

Compared to the ferroelectric PVDF polymer, the dielectric response of the low loss PC polymer is generally frequency independent, having a purely real dielectric constant ∈_{PC}=2.56. The material in the core is air, having a dielectric constant ∈_{core}=1.0.

From the above, it can be deduced that any two materials, having respective different dielectric functions, but with one dielectric function behaving as that of Equation (1) and the other dielectric function being constant or slightly varying, can be used to form the hollow Bragg fiber as illustrated in FIGS. 1-3 for use as THz waveguide.

When material losses are negligible and the number of reflector periods is infinite (i.e. an infinite reflector), the theory of planar periodic reflectors as described in Reference [22] predicts that, for a given angle of incidence θ onto such a reflector, there exists a wavelength λ_{c} for which light radiation of any polarization is reflected completely. In this case, a total internal reflection (TIR) is obtained.

For a multilayer reflector, the modal effective refractive index is defined as:

n_{eff}=n_{c} sin(θ)

while ñ_{PVDF}=\sqrt{n_{PVDF}²−}n_{eff}² and ñ_{PC}=\sqrt{n_{PC}²−}n_{eff}²,

then λ_{c}/2=d_{PVDF}ñ_{PVDF}+d_{PC}ñ_{PC}

where n_{c} is the refractive index of the core in the case of a waveguide, and in the case of a semi-infinite reflector, n_{c} is the refractive index of the medium from which the light arrives onto the semi-infinite reflector surface (generally, it is air); n_{PVDF} is the refractive index of the ferroelectric PVDF polymer, and n_{PC} is the refractive index of the low loss PC polymer.

Around the wavelength λ_{c}, there exists a wavelength range Δλ, called the band gap. For any wavelength inside of the band gap, light radiation is still completely reflected. The relative size of this band gap is proportional to the relative index contrast |ñ_{PVDF}−ñ_{PC}|/average(ñ) in the multilayer reflector and is given by the following relation:

Δλ/λ_{c}˜|ñ_{PVDF}−ñ_{PC}|/average(ñ)

where average(\tilde{n})=(ñ_{PVDF}+ñ_{PC})/2

The width of the band gap is maximized for a so-called quarter-wave reflector λ_{c}/4, where d_{PVDF}ñ_{PVDF}=d_{PC}ñ_{PC}=λ_{c}/4. The efficiency of a finite reflector correlates with the width of the band gap of a corresponding infinite reflector.

The real and imaginary parts of the refractive indices of the PVDF/PC material combination are presented in FIG. 4. In the region 41 where the frequency ω≦0.2 THz and the region 42 where 2.0≦ω≦2.6 THz, losses in the ferroelectric PVDF polymer material are small Im(n)<<Re(n), while the relative refractive index contrast is high suggesting the possibility of designing an efficient periodic reflector featuring a wide band gap. In the region 43 where 0.6≦ω≦2.0 THz, the real part of the PVDF refractive index is smaller than that of air, resulting in total internal reflection from the multilayer interface. Therefore, FIG. 4 gives the different optical properties of any two material combination, which can be used for the THz waveguides. It should be noted that the low loss PC polymer does not necessarily present a constant refractive index but it can exhibit slight variations in the real and imaginary parts of its refractive index.

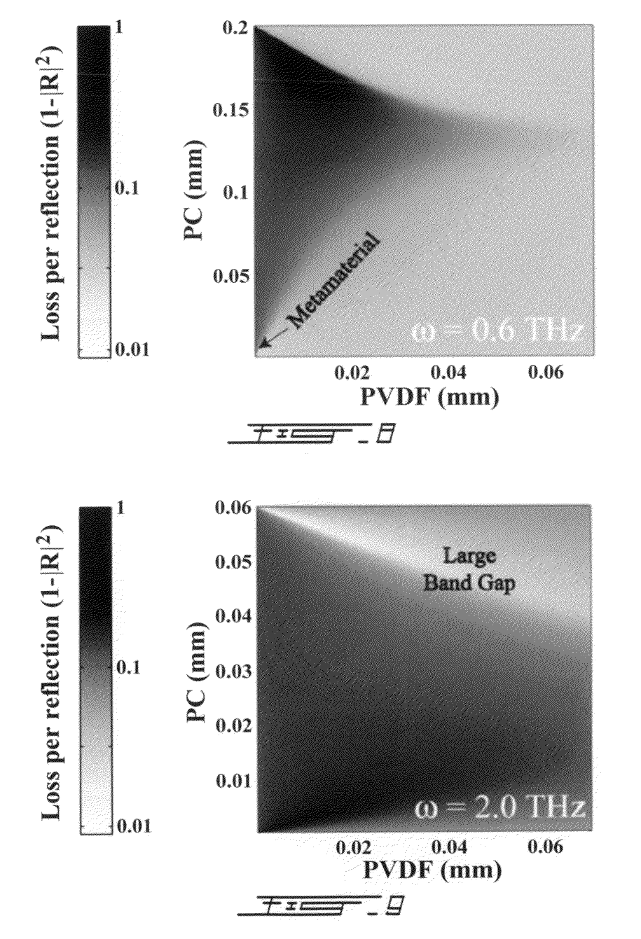

Now turning to FIGS. 7 to 11, an optimization method is shown graphically for multilayer planar reflectors, since no analytical formulas are available.

Generally, the terahertz region is defined over the range of 0.1 to 10 THz, the subrange of 1 to 3 THz being the most popular region.

More specifically, FIGS. 7 to 11 show the transmission loss per single reflection from an infinitely periodic reflector for the lossiest TM (Transverse Magnetic) polarized plane wave (when the magnetic field is parallel to the reflector interface), for different frequencies ω so as to form loss maps. A grazing angle of incidence θ is fixed and equal to 89° (see FIG. 6, where I represents an incident signal and R represents a reflected signal). However, other angles of incidence can be used in the optimization method, for example, the incidence angle can be given by the range between [θₘᵢₙ, . . . , θₘₐₓ]. The loss maps defines different regions of regimes of optimal operations and performance for the multilayer planar reflectors.

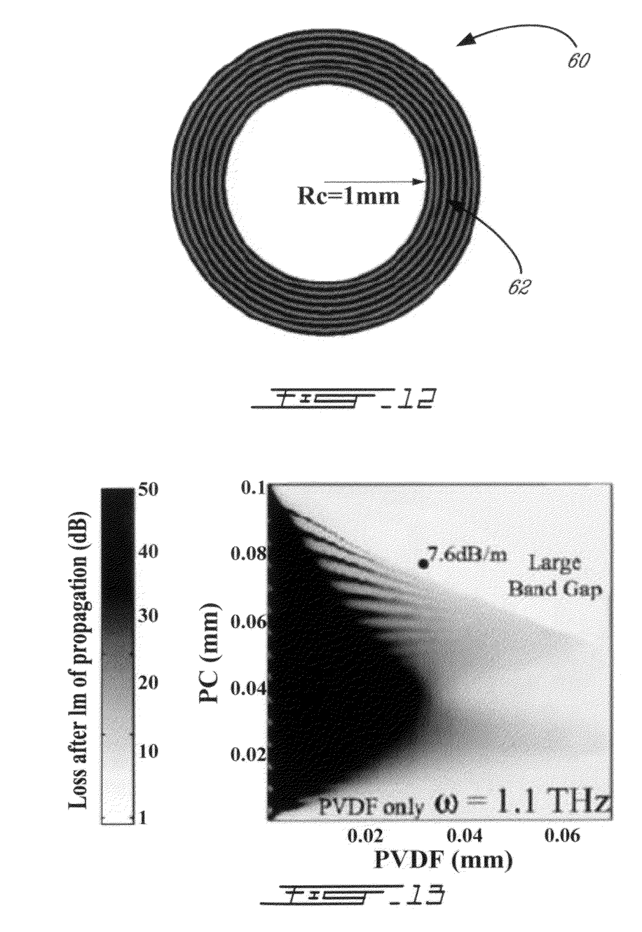

For each frequency ω, the transmission loss is presented in shades of gray (with white: low loss to black: high loss) as a function of the multilayer reflector layer's thicknesses d_{PVDF} and d_{PC} (FIG. 6). As the PC polymer is assumed to be low loss or lossless, all the loss maps represented in FIGS. 7 to 11 are periodic along the d_{PC} axis, where only one period is shown. For ω=3 THz (FIG. 11) and higher, due to small refractive index contrasts between the layers, the multilayer reflector band gap is small and the multilayer reflector efficiency is low. In this regime, reflection from the periodic multilayer reflector is similar to the reflection from a simple semi-infinite slab of some averaged dielectric constant.

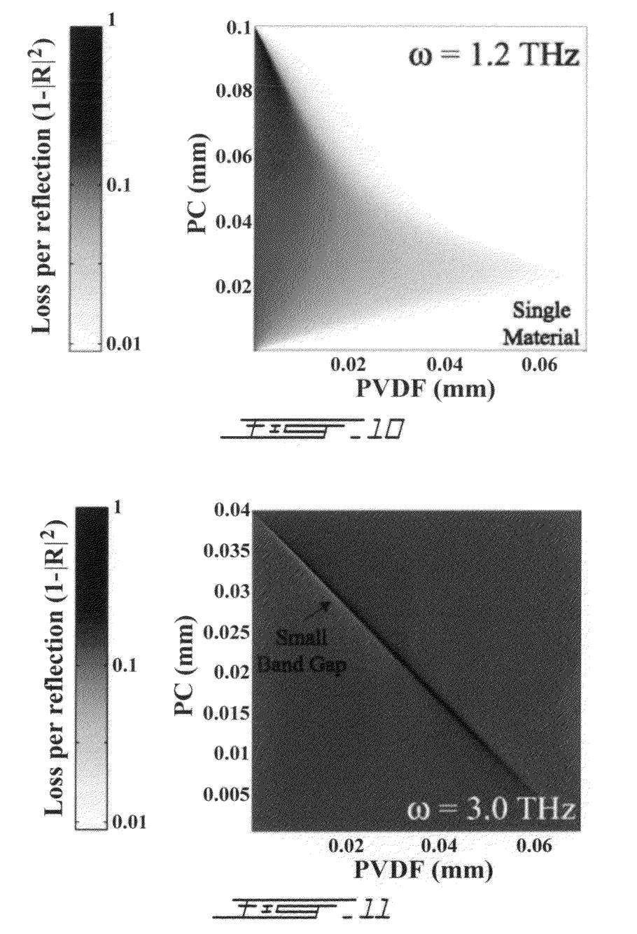

For ω=0.1 THz (FIG. 7) and ω=2.0 THz (FIG. 9), optimal reflectors have large band gaps. This may be seen from the extended regions of phase space (d_{PVDF}, d_{PC}) characterized by a high reflector efficiency, i.e. the white regions. This first regime can be called the regime of high band gaps.

In a second regime, a region of total internal reflection TIR can be obtained as shown in FIG. 10, for ω=1.2 THz. Also, it may be observed that reflection may be made very efficient simply by using a ferroelectric PVDF layer, which is thick enough (roughly larger than 0.06 mm as shown in FIG. 10).

Finally, the lower frequencies 0.2≦ω≦0.6 THz (FIG. 8) define a third regime. In these lower frequencies, ferroelectric PVDF absorption becomes very large; therefore, in order to minimize the multilayer reflector loss, a metamaterial, in the form of a reflector with subwavelength period, becomes most efficient. In this configuration, the multilayer reflector loss is reduced below that of the ferroelectric PVDF polymer due to the presence of the low loss PC polymer.

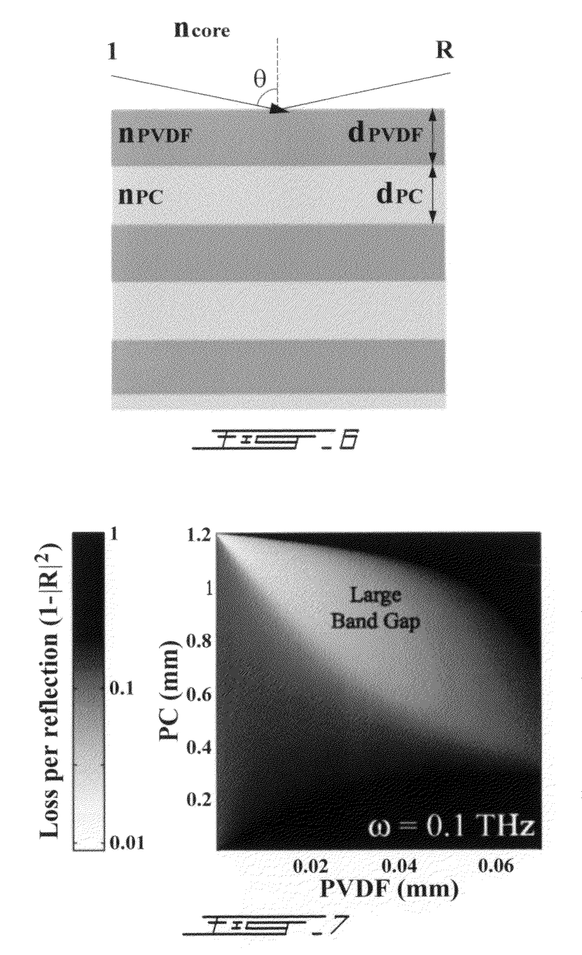

Referring to FIG. 5, optimization of a structure or geometry of a reflector for optimal performance in accordance with the frequency of operation and using the above described loss maps is shown. For example, the TM (Transverse Magnetic) reflection efficiency from an optimized semi-infinite periodic PVDF/PC reflector 51 is compared with the reflection efficiencies from semi-infinite slabs of PVDF 52 or PC 53. For a given frequency, an optimized reflector is found by first calculating a loss map, such as those shown in FIGS. 7 to 11, of the reflector as a function of the PVDF and PC layer thicknesses, and then choosing the structure with the lowest loss. The optimal reflector guiding mechanism is indicated in FIG. 5 on the frequency axis 54.

As shown in FIG. 5, reflection from a ferroelectric PVDF polymer layer 52 alone is very efficient in the frequency range of total internal reflection (TIR), when Re(n_{PVDF})<nₐᵢᵣ, where nₐᵢᵣ is the refractive index of the air. However, beyond this region of TIR, the PVDF layer 52 is highly absorbing and reflection from a single PC layer 53 becomes more efficient. As periodic multilayer reflectors offer a possibility of band gap guiding and metamaterial design, FIG. 5 shows that the optimized periodic PVDF/PC reflectors dramatically outperform single material reflectors. Finally, it should also be noted that at frequencies ω≅0.3,3.4 THz even the optimal reflectors become inefficient for the reflection of the TM polarized waves [22].

Optimization of a Bragg fiber will now be described.

FIG. 12 shows a non-limitative example of an optimized hollow all-polymer Bragg fiber 60, with a hollow core radius of 1 mm and a multilayer reflector 62. For example, the reflector 62 comprises thirty-one (31) layers of alternating ferroelectric PVDF and low loss PC polymer material.

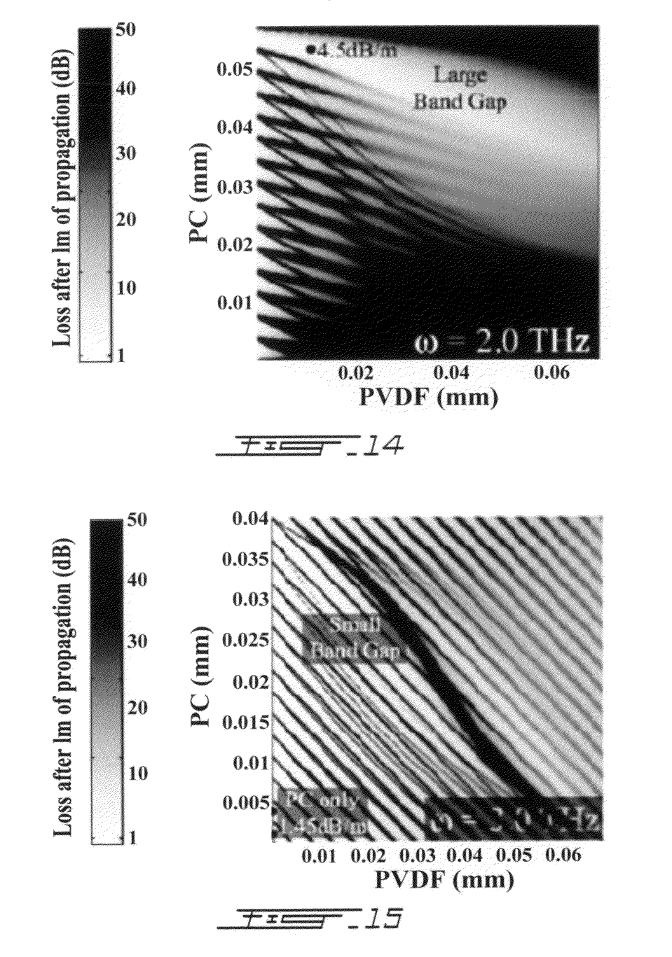

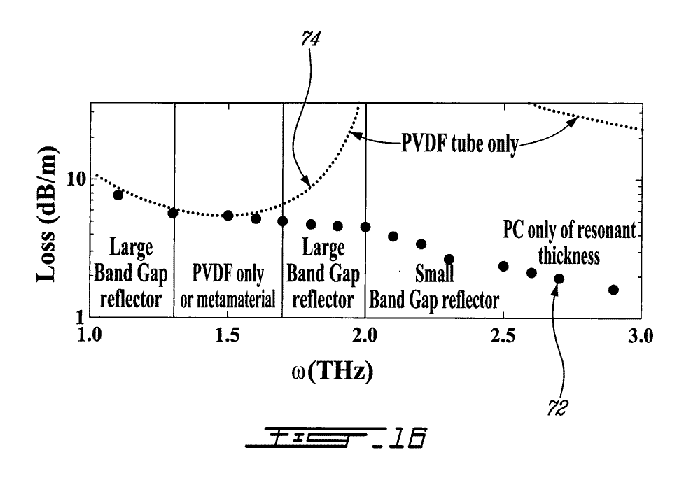

FIGS. 13 to 16 are loss maps showing the propagation loss of the optimized 1 mm diameter hollow core Bragg fiber 60 with the thirty-one (31) layer PVDF/PC reflector 62. At all frequencies, the geometry of the hollow all-polymer Bragg fiber 60 is found by first constructing the fiber loss maps, shown in FIGS. 13 to 15, and then choosing the reflector layer's thicknesses that minimize the fiber transmission loss. It may be noted that for frequencies of ˜1 THz, individual reflector layer thicknesses are typically ˜50 μm. At the input of the hollow all-polymer Bragg fiber 60, it is assumed that the excitation is a Gaussian beam of 0.77 mm diameter, which empirically gives the highest coupling efficiency (˜90%-98%) into the HE₁₁ Gaussian-like core mode of a hollow fiber.

To construct the fiber loss maps of FIGS. 13 to 15, for every choice of the reflector layer thicknesses, a mode solver may first be used to find all the leaky and guided transmission modes of the corresponding hollow Bragg fiber 60. The modal excitation coefficients are then found at the fiber input by expanding an incoming Gaussian beam into the fiber modal fields using the continuity of the transverse electromagnetic fields at the air-fiber interface. The excitation field is then propagated for 1 m. The remaining power at the fiber end is calculated, and the total loss is computed.

Simulations show that the coupling loss for the Bragg fiber 60 is typically smaller than 0.5 dB, and the total loss of the fiber span is always dominated by the fiber loss. As discussed hereinabove, radiation propagation in the hollow core of the Bragg fiber 60 can be thought of as a sequence of consecutive reflections upon the confining multilayer reflector 62. Thus, the loss of the Bragg fiber 60 is directly determined by the efficiency of the periodic multilayer reflector 62.

Comparing the loss maps of the planar multilayer reflector (FIGS. 7 to 11) with those of the Bragg fiber 60 (FIGS. 13 to 15), it can be seen that, at the corresponding frequencies, they behave in the same manner. Thus, the optimal design strategies for the Bragg fiber 60 are analogous to those for the planar multilayer reflectors.

For example, in the frequency region of 1.6-2.1 THz, the refractive index contrast in a multilayer reflector is high, while the PVDF loss is relatively low. As a result, the optimal Bragg fiber 60 is a band gap guiding fiber. FIG. 16 shows, in the 1.0-3.0 THz region, the transmission loss 72 of optimally designed Bragg fibers and marks the guidance mechanisms. For comparison, FIG. 16 also shows the losses of a PVDF tube 74 of the same bore radius as the Bragg fiber 60, from which it may be noted that for frequencies higher than 1.6 THz, the optimally designed Bragg fiber 60 considerably outperforms the PVDF tube 74.

Generally stated, near the transverse optical frequency of a ferroelectric polymer, a tube made of such a material can be used as an efficient hollow core terahertz waveguide. More specifically, a hollow core Bragg fiber with a periodic reflector containing ferroelectric polymer as one of its layers can be obtained. The resulting hollow Bragg fiber has then an optimally designed reflector which outperforms a ferroelectric tube guide. Moreover, depending on the frequency of operation, such optimally designed Bragg fibers may feature band gap, total internal reflection or antiresonant guiding.

The PVDF polymer may be replaced with, for example, a polymer containing piezoelectric or ferroelectric nanoparticles, or nanoclay ceramics.

The PC polymer can be replaced, as non-limitative examples, by a Polymethyl methacrylate (PMMA) and Polystyrene (PS), etc. The PC polymer may be also replaced with, for example, any plastic having low loss in the terahertz region.

Although the present invention has been described in the foregoing description by way of non-restrictive illustrative embodiments and examples thereof, it should be kept in mind that these embodiments and examples can be modified within the scope of the appended claims without departing from the scope and spirit of the present invention.

### REFERENCES

[1] R. H. Jacobsen, D. M. Mittleman, and M. C. Nuss, Opt. Lett. 21, 2011 (1996).
[2] D. M. Mittleman, S. Hunsche, L. Boivin, and M. C. Nuss, Opt. Left. 22, 904 (1997).
[3] T. Kiwa, M. Tonouchi, M. Yamashita, and K. Kawase, Opt. Lett. 28, 2058 (2003).
[4] K. Kawase, Y. Ogawa, Y. Watanabe, and H. Inoue, Opt. Express 11, 2549 (2003).
[5] T. Lffler, T. Bauer, K. Siebert, H. Roskos, A. Fitzgerald, and S. Czasch, Opt. Express 9, 616 (2001).
[6] M. C. Beard, G. M. Turner, J. E. Murphy, 0.1. Micic, M. C. Hanna, A. J. Nozik, and C. A. Schmuttenmaer, Nano Lett. 3, 1695 (2003).
[7] M. Y. Frankel, S. Gupta, J. A. Valdmanis, and G. A. Mourou, IEEE Trans. Microwave Theory Tech. 39, 910 (1991).
[8] R. Mendis and D. Grischkowsky, J. Appl. Phys. 88, 4449 (2000).
[9] S. P. Jamison, R. W. McGowan, and D. Grischkowsky, Appl. Phys. Left. 76, 1987 (2000).
[10] R. W. McGowan, G. Gallot, and D. Grischkowsky, Opt. Lett. 24, 1431 (1999).
[11] H. Han, H. Park, M. Cho, and J. Kim, Appl. Phys. Left. 80, 2634 (2002).
[12] M. Goto, A. Quema, H. Takahashi, S. Ono, and N. Sarukura, Jpn. J. Appl. Phys., Part 1 43, 317 (2004).
[13] R. Mendis and D. Grischkowsky, IEEE Microw. Wirel. Compon. Left. 11, 444 (2001).
[14] L. J. Chen, H. W. Chen, T. F. Kao, J. Y. Lu, and C. K. Sun, Opt. Lett. 31, 308 (2006).
[15] J. Harrington, R. George, P. Pedersen, and E. Mueller, Opt. Express 12, 5263 (2004).
[16] T. Hidaka, Proc. SPIE 5135, 11 (2003).
[17] T. Hidaka, H. Minamide, H. Ito, J. Nishizawa, K. Tamura, and S. Ichikawa, J. Lightwave Technol. 23, 2469 (2005).
[18] K. L. Wang and D. M. Mittleman, Nature (London) 432, 376 (2004).
[19] H. Cao and A. Nahata, Opt. Express 13, 7028 (2005).
[20] Y. Gao, N. Guo, B. Gauvreau, M. Rajabian, O. Skorobogata, E. Pone, O. Zabeida, L. Martinu, C. Dubois, and M. Skorobogatiy, J. Mater. Res. 21, 2246 (2006).
[21] E. Pone, C. Dubois, N. Guo, Y. Gao, A. Dupuis, F. Boismenu, S. Lacroix, and M. Skorobogatiy, Opt. Express 14, 5838 (2006).
[22] M. Skorobogatiy, Opt. Lett. 30, 2991 (2005).

What is claimed is:

1. A method for fabricating a terahertz waveguide, comprising:
forming a multilayer reflector formed of alternating layers of first and second polymer materials with distinct refractive indices; and
defining with the multilayer reflector a hollow core through which tetrahertz radiation propagates.

2. The method according to claim 1, wherein forming a multilayer reflector comprises deposing the alternating layers of the first and second polymer materials inside a rotating tube.

3. The method according to claim 1, wherein forming a multilayer reflector comprises:
depositing the alternating layers of the first and second polymer materials inside a rotating polymer tube so as to produce a preform of a first diameter; and
drawing a coaxial central portion of the preform having a second diameter smaller than the first diameter to form a hollow core fiber.

4. The method according to claim 1, wherein the first polymer material comprises a ferroelectric material.

5. The method according to claim 1, wherein the first polymer material comprises polyvinylidene fluoride (PVDF) polymer.

6. The method according to claim 1, wherein the second polymer material comprises a low loss material.

7. The method according to claim 6, wherein the low loss material comprises polycarbonate (PC) polymer.

8. The method according to claim 1, wherein the first polymer material comprises a ferroelectric polymer, and the second polymer material comprises a low loss polymer.

9. The method according to claim 1, wherein the first polymer material comprises polyvinylidene fluoride (PVDF) polymer, and the second polymer material comprises polycarbonate (PC) polymer.

10. The method according to claim 5, further comprising activating the PVDF polymer to obtain a ferroelectric PVDF polymer.

11. The method according to claim 10, wherein activating the PVDF polymer comprises applying a poling process to the PVDF polymer.

12. The method according to claim 3, wherein deposing the alternating layers of the first and second polymer materials comprises using solvent evaporation of the first and second polymer materials.

13. The method according to claim 10, wherein activating the PVDF polymer comprises adding in the PVDF polymer at least one of the following additives: nanoclays and ferroelectric powders.

14. The method according to claim 1, wherein forming a multilayer reflector comprises forming a cylindrical multilayer reflector formed of the alternating layers of the first and a second polymer materials to form a hollow core Bragg fiber.

15. The method according to claim 1, further comprising optimizing the tetrahertz waveguide by:
constructing, for a given frequency, a transmission loss map of the tetrahertz waveguide as a function of respective thicknesses of the alternating layers of the first and a second polymer materials; and
selecting, in relation to the transmission loss map, the respective thicknesses of the alternating layers of the first and second polymer materials which minimizes transmission loss in a frequency band gap around said given frequency.

16. The method according to claim 1, wherein forming a multilayer reflector comprises:
co-rolling and solidifying two films of the first and second polymer materials, respectively.

17. The method according to claim 1, wherein forming a multilayer reflector comprises:
co-rolling and solidifying two films of the first and second polymer materials, respectively, to produce a preform having a first diameter; and
drawing a coaxial central portion of the preform having a second diameter smaller than the first diameter to form a hollow core fiber.

18. The method according to claim 1, wherein the multilayer reflector comprises a planar multilayer reflector, used as an all-dielectric flat mirror for terahertz propagation.

19. A terahertz waveguide, comprising:
a multilayer reflector formed of alternating layers of first and second polymer materials with distinct refractive indices; and
a hollow core defined by the multilayer reflector and through which tetrahertz radiation propagates.

20. The waveguide according to claim 19, wherein the multilayer reflector is made from a preform comprising the alternating layers of the first and second polymer materials deposited inside a tube and comprises a hollow core fiber formed of a coaxial central portion drawn from the preform and having a second diameter smaller than the first diameter to form a hollow core fiber.

21. The waveguide according to claim 19, wherein the first polymer material comprises a ferroelectric material.

22. The waveguide according to claim 19, wherein the first polymer material comprises polyvinylidene fluoride (PVDF) polymer.

23. The waveguide according to claim 19, wherein the second polymer material comprises a low loss material.

24. The waveguide according to claim 23, wherein the low loss material comprises polycarbonate (PC) polymer.

25. The waveguide according to claim 19, wherein the first polymer material comprises a ferroelectric polymer, and the second polymer material comprises a low loss polymer.

26. The waveguide according to claim 19, wherein the first polymer material comprises polyvinylidene fluoride (PVDF) polymer, and the second polymer material comprises polycarbonate (PC) polymer.

27. The waveguide according to claim 22, wherein the PVDF polymer is a ferroelectric PVDF polymer.

28. The waveguide according to claim 22, wherein the PVDF polymer comprises at least one additive selected from the group consisting of nanoclays and ferroelectric powders.

29. The waveguide according to claim 19, wherein the multilayer reflector comprises a cylindrical multilayer reflector formed of the alternating layers of the first and a second polymer materials to form a hollow core Bragg fiber.

30. The waveguide according to claim 19, wherein the alternating layers of the first and second polymer materials have respective thicknesses determined by:
constructing, for a given frequency, a transmission loss map of the tetrahertz waveguide as a function of respective thicknesses of the alternating layers of the first and a second polymer materials; and
selecting, in relation to the transmission loss map, the respective thicknesses of the alternating layers of the first and second polymer materials which minimizes transmission loss in a frequency band gap around said given frequency.

31. The waveguide according to claim 19, wherein the multilayer reflector is made from two films of the first and second polymer materials, respectively, co-rolled and solidified to produce a preform having a first diameter, and comprises a coaxial central portion drawn from the preform and having a second diameter smaller than the first diameter to form a hollow core fiber.

32. The waveguide according to claim 19, wherein the second polymer material comprises a material selected from the group consisting of Polymethylmethacrylate (PMMA) and Polystyrene (PS).

33. The waveguide according to claim 19, wherein the multilayer reflector comprises a planar multilayer reflector, used as an all-dielectric flat mirror for terahertz propagation.
